(19) United States
(12) Patent Application Publication
(10) Pub. No.: US 2009/0262666 A1
(43) Pub. Date: Oct. 22, 2009

(54) DIGITAL RADIO NETWORK, CIRCUIT OF A NODE OF A DIGITAL RADIO NETWORK, AND METHOD FOR SETTING UP A DIGITAL RADIO NETWORK

(76) Inventors: Dietmar EGGERT, Dresden (DE); Tilo Ferchland, Dresden (DE); Rolf Jaehne, Ottendorf-Okrilla (DE)

Correspondence Address: Muncy, Geissler, Olds & Lowe, PLLC, P.O. BOX 1364, FAIRFAX, VA, 22038-1364, US

(21) Appl. No.: 12/423,584

(22) Filed: Apr. 14, 2009

Related U.S. Application Data
(60) Provisional application No. 61/044,700, filed on Apr. 14, 2008.

(30) Foreign Application Priority Data
Apr. 14, 2008 (DE) 10 2008 018 870.0

(51) Int. Cl. H04L 12/28

(52) U.S. Cl. 370/254

(57) ABSTRACT

A digital radio network, a circuit of a node of a digital radio network, and method for setting up a digital radio network is provided, wherein a transmission power of the first node is set for a radio link between a first node of the digital radio network and a second node of the digital radio network. A sensitivity of a receiving circuit of the second node is set by programming a threshold with which a field-strength-dependent signal is compared. Signal processing of a received and digitized received signal by the second node is activated when the field-strength-dependent signal reaches or exceeds the programmed threshold.

This nonprovisional application claims priority to German Patent Application No. DE 10 2008 018 870.0, which was filed in Germany on Apr. 14, 2008, and to U.S. Provisional Application No. 61/044,700, which was filed on Apr. 14, 2008 and which are both herein incorporated by reference.

### BACKGROUND OF THE INVENTION

1. Field of the Invention

The present invention relates to a digital radio network, a circuit of a node of a digital radio network, and a method for setting up a digital radio network.

2. Description of the Background Art

Modern receiving circuits for radio high-frequency signals for use in local radio networks are characterized by a very high sensitivity up to close to the physically possible limit. Different radio networks at the same transmission frequency can interfere with each other. With an increasing density of radio networks, this can result in increasingly worsening transmission conditions. Radio networks of this type are described, for example, in the industry standards IEEE 802.11, IEEE 802.15.1, or IEEE 802.15.4.

### SUMMARY OF THE INVENTION

It is therefore an object of the present invention to improve a process for setting up a digital radio network as much as possible.

Accordingly, a method is provided for setting up a digital radio network. The setting up occurs, for example, during the startup procedure or modification of the digital radio network.

For the setting up, a transmission power of the first node is set for a radio link between a first node of the digital radio network and a second node of the digital radio network. Preferably, the transmission power is set depending on a measured or predetermined distance to the second node and/or to additional nodes of the radio network and/or depending on the transmission conditions, such as attenuation through walls, etc.

For the setting up, furthermore, a sensitivity of a receiving circuit of the second node for receiving for the radio link is set by programming a threshold. The programming occurs, for example, during the startup procedure or modification of the digital radio network. For the setting up and during operation of the radio network, a field-strength-dependent signal is compared with the threshold.

Signal processing of a received and digitized received signal by the second node can be activated for the radio link when the field-strength-dependent signal reaches or exceeds the programmed threshold. Accordingly, signal processing is not activated when the field-strength-dependent signal remains below the threshold.

The sensitivity of the second node can be adjusted in such a way that a field-strength-dependent signal due to the transmission power of the first node and determined by means of the receiving circuit of the second node exceeds the threshold of the second node.

A field-strength-dependent signal can also be formed during ongoing operation. A so-called RSSI signal (Received Signal Strength Indication) may be used as a field-strength-dependent signal, for example. In this regard, the invention is not limited to an RSSI signal; therefore, other field-strength-dependent signals may also be used.

A logic one or a logic zero can be output as the comparison result of the comparison between the field-strength-dependent signal and the programmed threshold.

The invention also provides as improved a digital radio network as possible.

Accordingly, a digital radio network with a first node and a second node is provided.

The first node can be formed to set a transmission power. For example, an amplification of a power amplifier of the first node is settable continuously or in steps by applying a control signal over an interface.

The first node can be set up to receive a command for setting the transmission power. The command for setting the transmission power is transmitted over a cable interface or over a radio link as the interface.

The second node can be formed to set a sensitivity of a receiving circuit of the second node. The receiving circuit is set up to form at least one field-strength-dependent signal and to compare the field-strength-dependent signal with the programmed threshold.

The second node can be set up for the radio reception of a command for setting the sensitivity. The command for setting the sensitivity is transmitted over a radio link, for example, between the first node and the second node.

For setting up the digital radio network, the sensitivity of the second node is adjusted to a field-strength-dependent signal due to the transmission power of the first node in such a way that the field-strength-dependent signal due to the transmission power of the first node exceeds the programmed threshold.

Preferably, the receiving circuit of the second node has means to program the threshold, to form the field-strength-dependent signal, to compare the field-strength-dependent signal with the programmed threshold, and to activate signal processing of a received and digitized received signal, when the field-strength-dependent signal reaches or exceeds the programmed threshold.

The invention furthermore has the object of providing as improved a circuit of a node of a digital radio network as possible.

Accordingly, a circuit of a digital radio network node is provided. The circuit is set up to receive a received signal and to digitize it for evaluation. A threshold for setting a circuit receive sensitivity is programmable. Preferably, a memory and a digital comparator are provided to program the threshold.

The circuit can be set up to evaluate a command for programming the threshold from the received signal in a mode for setting up the digital radio network.

The circuit can be set up to form at least one field-strength-dependent signal from the received signal and to compare the field-strength-dependent signal with the programmed threshold in a mode for communication in the digital radio network.

The circuit can be set up to activate signal processing of the digitized received signal when the field-strength-dependent signal reaches or exceeds the programmed threshold.

Preferably, the circuit has a register to store the programmable threshold for comparison with the field-strength-dependent signal. The field-strength-dependent signal and the register are preferably used to set the sensitivity of the receiving circuit of a digital radio network.

The embodiments described hereinafter refer to both the digital radio network and the method for setting up the digital radio network.

In an embodiment, the sensitivity of the receiving circuit of the second node can be set depending on the transmission power of the first node. Preferably, in this case, the setting occurs in such a way that the threshold is exceeded by a field-strength-dependent signal with a minimum exceeding, when the first node transmits with the set transmission power. The desired setting can be determined either from measured values or calculated proceeding from a geometric arrangement of the radio network nodes.

According to an embodiment, the sensitivity of the receiving circuit of the second node can be set depending on a field-strength-dependent signal measured by the receiving circuit. In a first embodiment variant, the measured field-strength-dependent signal depends on the transmission power of the first node. In a second embodiment variant, which can also be combined with the first embodiment variant, the measured field-strength-dependent signal is determined from a received signal of an interferer outside the network.

In an embodiment, it is provided that the sensitivity of the receiving circuit of the second node is set depending on a distance between the first node and the second node. For example, each sensitivity stage is assigned to a distance range (in meters or kilometers). In this regard, the sensitivity is set in such a way that for the distance range at a given transmission power of the first node a field-strength-dependent signal exceeds the threshold by a minimum value.

A further embodiment provides that the sensitivity of the receiving circuit of the second node is set in a measuring procedure. To this end, the sensitivity is set depending on a field-strength-dependent signal of a measurement. For example, the first node transmits with a predefined transmission power. The second node determines the field-strength-dependent signal within the measurement. A lower threshold is determined which is separated from the field-strength-dependent signal by a minimum value.

According to an embodiment, the circuit of a node is set up and formed in the mode for setting up the digital radio network to transmit a measured value of the field-strength-dependent signal to another node. This makes possible that both the transmission power of a transmitting node and the sensitivity of a receiving of a receiving node in a radio network can be optimized with a plurality of nodes and possibly interferers outside the network.

In embodiment, preamble detection and/or header analysis and/or determination of the transmitted data can occur for signal processing. The preamble detection in this case enables checking whether the signal preferably received over an antenna belongs to a radio network type, for example, according to industry standard IEEE 802.15.4. It is possible in this way to determine signals from nodes outside the network as well and to adjust the sensitivity and/or transmission power in nodes within the range of the “own” radio network. Preferably, to this end, the preamble detector is activated when the threshold is reached or exceeded. In the positive case of the check, header analysis occurs, for example, in regard to the association with the specific set-up radio network. Optionally, a determination of the transmitted data can then occur.

According to an embodiment, the signal processing is deactivated after processing of a frame with transmitted data. The deactivation occurs here preferably when the field-strength-dependent signal is simultaneously below the threshold. Otherwise, the search for a preamble in the received signal is continued or repeated by the receiving circuit.

In an embodiment, for deactivation an operating current is cut off from at least one circuit for signal processing. For the cutoff, it is sufficient for a CMOS circuit to turn off the clock signal applied at the CMOS circuit. Alternatively, cutting off the supply voltage is also possible, for example, for bipolar circuits.

According to an embodiment, the field-strength-dependent signal is formed as a real-time determination. Preferably, the formation occurs here independent of a serial or parallel interface and preferably independent of an arithmetic logic unit, such as a microcontroller, so that waking up of the arithmetic logic unit from the sleep mode is not necessary.

In another embodiment, the activation can occur within a transmission of a preamble. Preferably, the activation occurs in an initial section of the preamble, so that synchronization, for example, by correlation by means of a cross correlator is still possible.

An embodiment provides that the receiving circuit has a register, in which a register value can be stored as a threshold for programming. Preferably, the receiving circuit has a measuring circuit for measuring the field strength of a received signal and for outputting the field-strength-dependent signal. Preferably, the receiving circuit has a comparator, which is formed to compare the field-strength-dependent signal with the register value as a threshold. Preferably, the receiving circuit has a signal processing circuit, which has a control input for activating signal processing. The control input is functionally connected to an output of the comparator.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 a schematic block circuit diagram of a receiving circuit of an exemplary embodiment;

FIG. 2 a schematic illustration of two digital radio networks with locally arranged nodes; and

FIG. 3 a schematic diagram.

### DETAILED DESCRIPTION

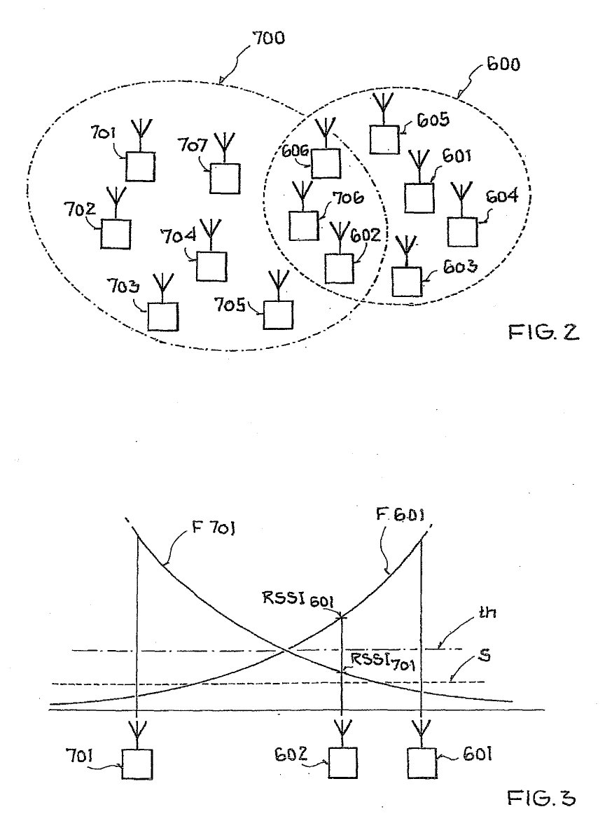

Modern receiving circuits, which are used in local radio networks, are characterized by increasingly better sensitivity up to the physical limit. An increase in the receiving range is associated with this, which enables digital radio networks that span a larger area. In FIG. 2, by way of example, a first radio network 600 with nodes 601 to 606 and a second radio network 700 with nodes 701 to 707 are shown schematically in their geometric expansion. For example, node 602 is within the receiving range of the two independent radio networks 600, 700. If there are several independent radio networks with the same transmission frequency within the receiving range, these networks 600, 700, interfere with each other. With increasing density of radio networks, this leads to increasingly poorer transmission conditions. In the exemplary embodiment of FIG. 2, each node 601 to 606 and 701 to 707 of the radio networks 600, 700 can both receive signals and transmit signals.

Collisions during the receiving of data packets arise whenever the processing of a data packet was begun and a new data packet is received in the meantime. At least within the time until it is recognized that the just received data packet is not to be processed, the receiver is not sensitive to additional data packets even if these were to be received with a much higher field strength over the antenna. In FIG. 3, field strengths F601 and F701 for both radio networks 600, 700 are shown in an example in which collisions can occur.

It is assumed in regard to the exemplary embodiment of FIG. 3 that in the examined “own” radio network 600, node 601 functions as a transmitter and node 602 as a receiver. Node 701 is the transmitter in the “foreign” radio network 700 and acts as an interferer in this exemplary embodiment. Both transmitter nodes 601 and 701 transmit a signal with a similar field strength curve F601 and F701 in the exemplary embodiment of FIG. 3, which declines with increasing distance from the particular transmitter 601, 701. At the site of receiver node 602, the received field strengths F601 and F701 of both transmitters 601 and 701 are greater than the best possible sensitivity threshold s of receiver node 602. Both transmitters 601 and 701, however, do not “see” the respectively other transmitter 701 or 601, because the field strength F601 or F701, received in each case, is below the best possible sensitivity threshold s. Thus, both transmitters 601, 701 could transmit simultaneously. As a result, a virtually simultaneous appearance of data packets from both transmitters 601, 701, can occur at receiver node 602.

The exemplary embodiment of FIG. 3 provides a settable threshold th, with which the sensitivity of receiver node 602 can be set individually. The settable threshold th is freely programmable between values corresponding to the best possible sensitivity threshold s for a maximum sensitivity and a minimum sensitivity for each node 601 to 606 and 701 to 707.

Digital radio network 600 is set up during the startup procedure or modification of said network by addition or omission of a node. To set up digital radio network 600, a transmission power of first node 601 is set for a radio link between a first node 601 of digital radio network 600 and a second node 602 of digital radio network 600. The transmission power is shown schematically in FIG. 3 as a maximum value of the field strength F601 at the site of first node 601.

In addition, a sensitivity of a receiving circuit of second node 602 is set by programming a threshold th. For this threshold th to be effective, its programming is accordingly necessary. During operation, a field-strength-dependent signal RSSI601, RSSI701 is formed. The field-strength-dependent signal RSSI601, RSSI701 is compared with the programmed threshold th, for example, by means of a comparator. It is shown in FIG. 3 that the field-strength-dependent signal RSSI701 of the “foreign” transmitter 701 according to the setup of digital radio network 600 is below the programmable threshold th. Accordingly, signal processing of the optionally digitized received signal received from transmitter 701 is not activated. In contrast, signal processing for the digitized received signal received from transmitter 601 is activated, because the field-strength-dependent signal RSSI601 exceeds the programmed threshold th.

This sensitivity for each receiver can be adjusted to the receiving conditions individually and to the transmission powers of the transmitting nodes by means of the threshold th and thereby a more or less large part of the interfering foreign transmitters is faded out and set for reliable receiving. The range-determining maximum sensitivity in this case is retained for the network nodes that require it due to the greater distances or poorer transmission conditions. A range optimization also occurs by setting the transmission power. Adjustment of the transmission power of nodes of “foreign” radio networks to the transmission conditions in the “own” radio network is not often possible, however, when the neighboring digital radio networks are not administered jointly. The mutual influencing of neighboring radio networks is reduced in a simple manner and the current consumption due to interferers drastically reduced with the threshold th by the exemplary embodiment of FIG. 3.

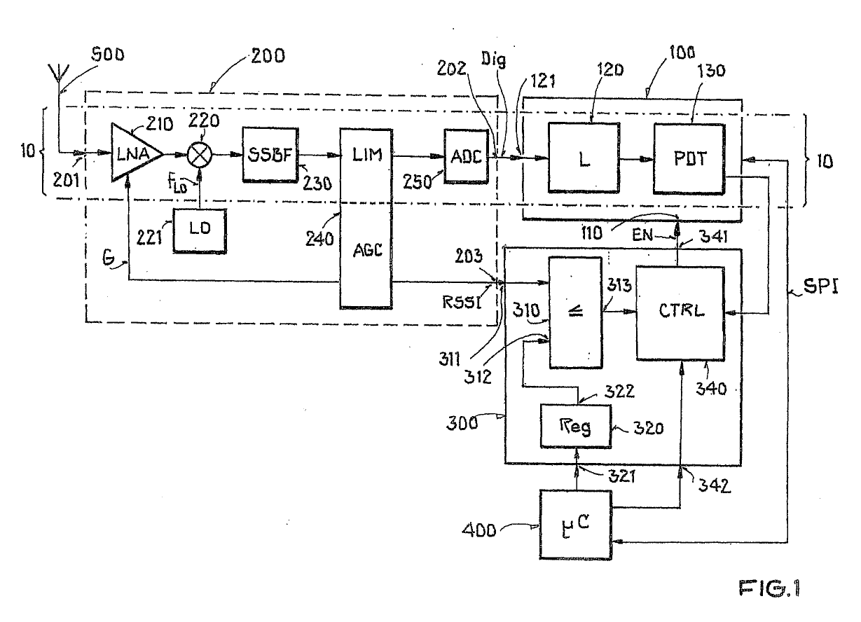

FIG. 1 shows an exemplary embodiment of a receiving circuit, for example, for a radio network according to the industry standard IEEE 802.15.4. The analog part 200 of the receiving circuit in receive path 10 has an amplifier (LNA, Low-Noise Amplifier) 210 and a mixer 220. A local oscillator (LO) 221 to output an oscillator signal f_{LO} is connected to mixer 220. Furthermore, analog part 200 of the receiving circuit has a filter component (SSBF, Single Site Band filter) 230, a limiter/amplifier (LIM/AGC, Automatic Gain Control) 240, and an analog-to-digital converter (ADC) 250. A transmission circuit for transmitting data to another node is not shown.

The high-frequency signal received over antenna 500 is applied at input 201 and is amplified in low-noise amplifier 210. The amplified high-frequency signal is transformed by mixer 220 and local oscillator 221 into the baseband. The additional analog signal processing has a frequency-selective filtering in filter 230, postamplification by means of limiter/amplifier 240, and conversion into a digital signal Dig for output 202 by means of analog-to-digital converter 250.

The limiter/amplifier 240 is formed for the formation of the field-strength-dependent signal RSSI, which is output at output 203. In synergy, limiter/amplifier 240 is formed to control an automatic amplification setting by means of the signal G. Digital signal processing circuit 100 has various digital functional blocks in receive path 10, for example, a logic (L) 120 and a preamble detector 130 (PDT). Digital signal processing circuit 100 has a signal input 121 and a control input 110, whereby one or more functional blocks 120, 130 of digital signal processing circuit 100 can be activated by means of a control signal EN at control input 110.

The field-strength-dependent signal RSSI is compared in a digital comparator 310 of a control circuit 300 with a register value stored in register (Reg) 320 as threshold th. The register value in register 320 is programmable via an input 321, for example, by means of microcontroller (μC) 400. To this end, an output 322 of register 320 is connected to an input 312 of the digital comparator. Output 313 of digital comparator 310 is connected to a control circuit (CTRL) 340. Furthermore, control circuit 340 is connected to digital signal processing circuit 100.

If the field-strength-dependent signal RSSI reaches or exceeds the register value, the output signal of digital comparator 310 reaches control circuit 340, which activates the digital signal processing, dependent thereon, by means of the control signal EN at output 341 for signal processing circuit 100. If a data packet has been completely received, control circuit 340 is set back by signal processing circuit 100 in a self-sustaining manner, so that the digital signal processing is deactivated. To this end, for example, the clock signal for signal processing circuit 100 can be turned off. Furthermore, a connection via input 342 for the configuration of control circuit 340 by microcontroller 400 is provided. Moreover, signal processing circuit 100 is connected over a serial interface SPI to microcontroller 400. For example, a command for recording a register value in register 320 to set the sensitivity of the receiving circuit from the received radio signal can be transmitted over the interface SPI to microcontroller 400.

The invention is not limited to the shown embodiment variants in the figures. For example, it is possible to provide an analog comparator instead of a digital comparator 310, whereby a voltage value is made available as an analog threshold instead of the register value. The functionality of the receiving circuit according to the exemplary embodiment of FIG. 1 is used especially advantageously for a radio network of the industry standard IEEE 802.11, IEEE 802.15.1, or IEEE 802.15.4.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for setting up a digital radio network, the method comprising:
setting a transmission power of the first node for a radio link between a first node of the digital radio network and a second node of the digital radio network;
setting a sensitivity of a receiving circuit of the second node by programming a threshold with which a field-strength-dependent signal is compared; and
activating signal processing of a received and digitized received signal by the second node when the field-strength-dependent signal reaches or exceeds the programmed threshold.

2. The method according to claim 1, wherein the sensitivity of the receiving circuit of the second node is set depending on the transmission power of the first node.

3. The method according to claim 1, wherein the sensitivity of the receiving circuit of the second node is set based on a field-strength-dependent signal measured by the receiving circuit, and wherein the measured field-strength-dependent signal depends on the transmission power of the first node.

4. The method according to claim 1, wherein the sensitivity of the receiving circuit of the second node is set depending on a distance between the first node and the second node.

5. The method according to claim 1, wherein the sensitivity of the receiving circuit of the second node is set based on a measured field-strength-dependent signal, and wherein the measured field-strength-dependent signal is determined from a received signal from an interferer outside the network.

6. The method according to claim 1, wherein for signal processing preamble detection and/or header analysis and/or determination of the transmitted data occur.

7. The method according to claim 1, wherein the signal processing is deactivated after processing of a frame with transmitted data, and wherein for the deactivation, an operating current is cut off from at least one circuit for signal processing.

8. The method according to claim 1, wherein the field-strength-dependent signal is formed as a real-time determination.

9. The method according to claim 1, wherein the activation occurs within, preferably in an initial section, of a transmission of a preamble.

10. A digital radio network comprising:
a first node being configured to set up a transmission power and configured to receive a command for setting the transmission power; and
a second node, configured to set a sensitivity of a receiving circuit of the second node, the receiving circuit being configured to form at least one field-strength-dependent signal and being configured to compare the field-strength-dependent signal with a programmed threshold, the second node being configured for radio reception of a command for setting the sensitivity,
wherein for setting up the digital radio network, the sensitivity of the second node is adjusted to a field-strength-dependent signal due to the transmission power of the first node for exceeding the programmed threshold.

11. A circuit of a node of a digital radio network, which is set up to receive a received signal and to digitize it for evaluation, to program a threshold for setting a receive sensitivity, to evaluate a command for programming the threshold from the received signal in a mode for setting up the digital radio network, to form at least one field-strength-dependent signal from the received signal, to compare the field-strength-dependent signal with the programmed threshold in a mode for communication in the digital radio network, and to activate signal processing of the digitized received signal when the field-strength-dependent signal reaches or exceeds the programmed threshold.

12. The circuit according to claim 11, which is set up to transmit a measured value of the field-strength-dependent signal to another node in the mode for setting up the digital radio network.

13. The circuit particularly according to claim 11, comprising:
a register in which a register value can be stored as a threshold for programming;
a measuring circuit for measuring the field strength of a received signal for outputting the field-strength-dependent signal;
a comparator configured to compare the field-strength-dependent signal with the register value as a threshold, and
a signal processing circuit, which has a control input for activating signal processing, which is functionally connected to an output of the comparator to control signal processing.
